(19) United States
(12) Patent Application Publication
(10) Pub. No.: US 2026/0183929 A1
(43) Pub. Date: Jul. 2, 2026

(54) Low Profile Cushion Grips for Isosceles Trapezoid Shaped Utility Blades

(71) Applicant: Mark James Grote, Oakbrook Terrace, IL (US)

(72) Inventor: Mark James Grote, Oakbrook Terrace, IL (US)

(21) Appl. No.: 19/004,256

(22) Filed: Dec. 28, 2024

(51) Int. Cl. B25G 1/10; B21D 22/02; B26B 5/00

(52) U.S. Cl. CPC B25G 1/102; B21D 22/02; B26B 5/006

(57) ABSTRACT

A low profile grip device grip formed on the upper edge of an isosceles-trapezoid shaped utility blade. The low profile grip may be attached to the blade with a plurality of methods. The dimensions of the grip vary based on the application but are defined by a grip length, grip depth, and grip thickness. Various materials may also be utilized for the grip. The grip is coupled to the blade by primer, an adhesive, a friction-fit, a fastener, a crimping force, a screw, a weld, or a blade-thruhole-pattern.

### BACKGROUND OF THE INVENTION

### Field of the Invention

The present invention relates to isosceles trapezoid shaped utility blades, which are used for a variety of projects and jobs such as paint-scraping, window-tint removal/scraping, cutting carburetor gaskets out of cork and other materials for historic cars, cutting matte board for art projects, removing pool glue from fresh pool installations, general arts and crafts, architectural modeling and endless professional and hobbyist grade jobs. These utility blades are popular for many projects due to the control and precision that they offer over the other blade types in the market. Prior art designs have not included low profile grips that allow a user to securely utilize this trapezoid style utility blade for projects.

The present invention relates to low profile cushioned grips for isosceles trapezoid shaped utility blades. Users often hurt their hands, fingers and thumbs using these blades without any type of grip. No substantial grip solution exists for this popular and particular style of blade. End users often use these blades with no grip or handle thus negatively impacting the cutting control and precision required for many applications. Many users even put electrical tape over them to act as a grip.

Isosceles trapezoid shaped utility blades vary in size for different uses but include the same essential design elements, specifically an upper edge, a lower cutting edge, and two vertical edges. The upper edge and lower cutting edge are generally parallel to each other and the two vertical edges are not parallel to each other. A common size is 2⅜″ long×0.75″ tall, but many other size variants are available. The acute tip angle, defined as the angle between the cutting edge and each vertical edge, generally ranges from 35°-65°. The obtuse non-sharp angles of the blades, defined as the angle between the upper edge and each vertical edge, generally ranges between 115°-145°. It is within these angle ranges that a more versatile and superior strength cutting tip is achieved. Acute tips are most often the reason end users choose X-ACTO knife blades, however they are brittle and easy to break. The rectangular utility blades that are well known in the art, aren't geared towards precision cutting as they have 90 degree angles on all sides making cutting awkward.

Grip devices with blades are commonly used by carpenters, painters, construction workers, craft builders, pool cleaners, artists, photographers, and many others to cut, scrape, and perform other similar tasks. Existing grip devices have an elongated handle or a substantial/large profile grip element relative to the low-profile designs disclosed herein. While some existing options have a much shorter handle than others, they still do not come close to such a perfect low-profile grip as the present invention. For purposes of this disclosure, a low-profile grip is differentiated from a typical handle by its substantial shortness and small size. The grip depicted herein, simply extends the holdable part of the existing blade with a comfortable grip, enabling the additional blade control required for precision cutting projects and jobs. Elongated handles and substantial/large profile grip elements, while appropriate for many projects, are very difficult to use for many detailed oriented precision projects. Having a low-profile grip directly coupled to the blade, essentially a small and cushioned extension of the blade itself, allows a user to keep their fingers as close to the cutting or scraping edge as possible. This close coupling of the blade to the user's fingers and cutting surface yields users much improved maneuverability and control over the blade without injuring or causing pain in their fingers, thumbs, or hands.

These types of blades are preferable in most situations over comparable X-ACTO® knife blades which have extremely brittle tips and long handles. The present invention is also preferrable for many uses than similar sized but rectangular shaped utility blades. Rectangular shaped utility blades are ideal for a scraping motion as they have 90° tips but this design negatively impacts accuracy and precision for many cutting applications. These rectangular blades include an extra metal thickness on the upper edge which a user may grip with their fingers and thumb to make it more comfortable and less painful. However, this thin, small and hard grip, which better than no grip at all, can still be very painful due to its small size and hard surface. The rectangular utility blade further lacks the acute blade angles of the isosceles trapezoid shaped blades. As outlined above, the acute angles of the isosceles-trapezoid-shape blade enables better precision, control, and comfort, especially when couple with the disclosed grip. The grip of the present invention is a suitable solution to many precision cutting and comfort issues that contractors, painters, artists, hobbyists, and DIY (Do-It-Yourself) enthusiasts encounter frequently.

### SUMMARY OF THE INVENTION

There is a need for a low profile grip device for isosceles trapezoid shaped utility blades that subjects a user's hands, fingers, and thumbs to substantially less pain (or no pain at all) when completing precision cutting projects. Further, the present invention enables a high level of control and precision for a wide variety of uses. In fact, uses previously ill-advised with an isosceles trapezoid shaped utility blade such as cutting ¼″ thick corkboard, are now possible with the control, precision, and comfort of the present invention. The many benefits, uses and improvements over prior solutions will be appreciated by those skilled in this technical art.

The low profile grip device for isosceles-trapezoid shaped utility blades includes an isosceles-trapezoid shaped utility blade and a low profile grip formed on the upper edge of the utility blade. The low profile grip may be attached to the blade with a plurality of methods. The dimensions of the grip vary based on the application but are defined by a grip length, grip depth, and grip thickness. Grip length is defined as the length of the grip laterally along the upper edge of the blade. Grip depth is the distance the grip travels vertically between the upper edge of the blade and the cutting edge of the blade. Grip thickness is the width of the grip at its widest point perpendicularly to the blade as gripped by a user. Various materials may also be utilized for the grip.

A first method of fabricating the present low profile grip claimed herein is possible with the following steps: 1) stamping or fine blanking steel blades, 2) removal of any anti-rust agent from the blades, 3) gripping any standard isosceles trapezoid shaped utility blade with the upper edge facing downward, 4) dip the upper edge of the blade to the desired grip height range in vinyl plastisol adhesive or primer (such as those produced under the Avient® brand) for binding a PVC resin to the blade, 5) allow the adhesive or primer to cure, and 6) dip the portion of the blade with the adhesive/prior into a plastisol PVC resin. The adhesive/primer step may be skipped, but that will result in a weaker bond between the resin and blade surface. The longer the blade remains within the dip, the thicker the grip will become.

This method may be duplicated with PVC resin products readily available to consumers such as those sold under the PLASTI DIP® brand. Using this method, each dip of the blade in the material will increase the grip thickness of the grip. For larger grip thicknesses, this method may prove time consuming due to the multiple times the grip must be dipped. This method may also include other materials that may improve the grip such as primer, adhesive, powder coat and other well known in the art. These materials may be applied by spraying, dipping, molding and other methods well known in the art.

An alternate method for manufacturing the present device includes the steps of 1) stamping or fine blanking steel blades into the required shape and sharpness, 2) coating any exposed metal with an anti-rust agent such as oil (as needed) for the type of metal used, 3) allocating and utilizing a selection of blades as template blades for dipping into an industrial plastisol tank in order to make grips, 4) the grips are then removed from the template dipping blades, 5) alternate blades are then coated with primer and/or coated with an adhesive, 6) the grips are then applied to the adhesive coated blades thus completing the product/invention embodiment.

An alternate method for manufacturing the present device includes the steps of 1) stamping or fine blanking steel blades into their shape and sharpness 2) coating any exposed metal with an anti-rust agent such as oil if needed for the type of metal used, 3) inserting the steel blades into an injection mold, 4) injecting the mold with a polymer such as a PVC. This embodiment may be achieved with multiple materials and methods well known in the art.

An alternate method for manufacturing the present device includes 1) casting a blade with its grip section as simply a larger part of the same casting, 2) An optional sharpening process for enhancing the sharpness of the sharp end of the blade, 3) coating any exposed metal with an anti-rust agent such as oil if needed for the type of metal used.

In any of the disclosed manufacturing processes it is possible to replace steel as the chosen metal with a different type of metal, alloy or composite. In some cases for certain applications a PVC or plastic substance/material may be used as the blade instead of a metal or steel where a softer sharp edge is needed by the end user, for example, scraping specific type of glass that may be scratchable by a metal or steel blade. In the event a plastic material is used as the blade, the anti-rust steps in any manufacturing process would then be void. In an event where a plastic is used as the blade the entire product may be injection molded in 1 step.

The present low profile grip device for isosceles trapezoid shaped utility blades provides a long needed and novel solution providing user comfort and cutting control/precision for this useful blade type.

### BRIEF DESCRIPTION OF THE DRAWINGS

FIG. 1 shows three prior art blade choices in use today.

FIG. 2 shows a view of a configuration of an isosceles trapezoid shaped utility blade used with the present invention.

FIG. 3 shows a view of an alternate configuration of an isosceles trapezoid shaped utility blade used with the present invention.

FIG. 4 shows a view of an isosceles trapezoid shaped utility blade with grip installed.

FIG. 5 shows a view of an alternate embodiment of an isosceles trapezoid shaped utility blade with grip installed.

FIG. 6 shows a side view of the grip without a blade installed.

FIG. 7 shows a cross-section view of the grip without a blade installed.

FIG. 8 shows a side view of the grip installed on a blade with a first configuration of holes.

FIG. 9 shows a side view of the grip installed on a blade with a second configuration of holes.

FIG. 10 shows a side view of the grip installed on a blade with a third configuration of holes.

FIG. 11 shows a perspective view of a blade with depressions or textures such as knurls.

FIG. 12 shows a perspective view of a blade with extrusions.

FIG. 13 shows an alternate embodiment of the grip.

FIG. 14 shows an alternate embodiment of an integrated grip that is formed as part of the blade.

FIG. 15 shows the embodiment of FIG. 14 with the integrated grip region containing a texture of etched marks across its surface area such as knurls.

FIG. 16 shows the embodiment of FIG. 15 with a coating over it and embedded into the etched marks for coupling, such as a PVC or plastic injection molding.

### DESCRIPTION OF THE PREFERRED EMBODIMENT

The following detailed description refers to the preferred embodiment of the disclosed invention as shown in the attached figures and in the below description. This detailed description is not meant to limit the scope of the invention in any way but is intended to disclose the preferred embodiment/best mode of the invention at the time of filing this application. A person of ordinary skill in the art may identify materials, methods, dimensions, shapes or other variations that are not disclosed but still fall within the scope of the present claims.

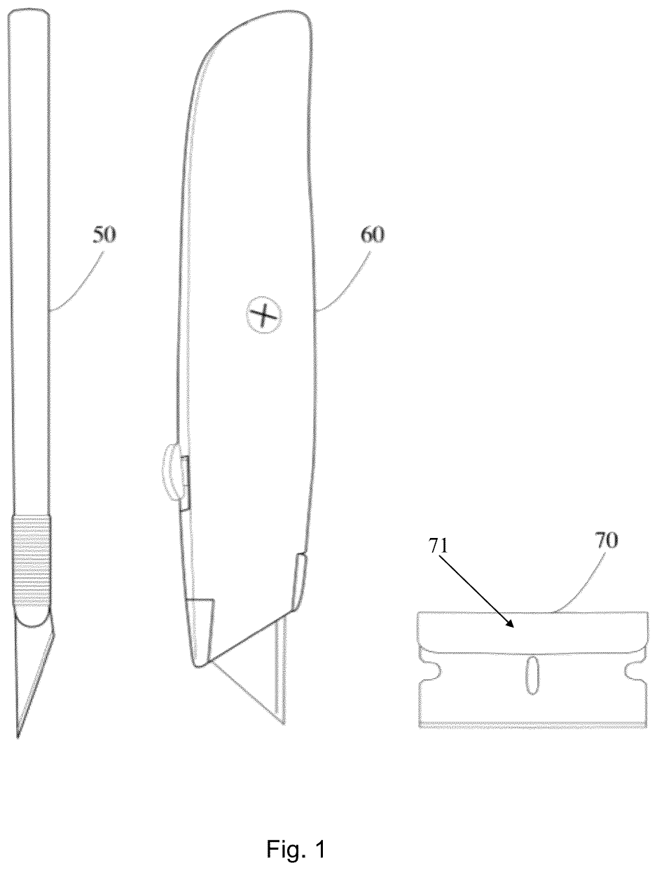

FIG. 1 depicts three of the most common blade choices used today for a variety of crafts and utilitarian purposes. None of these options offer a low profile grip for an acute tipped blade used for cutting and scraping. An isosceles trapezoid shaped utility blade is shown installed in handle 60. The angle and shape of handle 60 make precision cutting with this blade type difficult. A typical hobby knife 50, sometimes sold under the X-ACTO® brand, is shown on the left side. This blade provides relative comfort and precision cutting but has very brittle tips. These brittle tips cause the blade to break easily and make it a poor choice for many precision cutting tasks. Rectangular blade 70 has non-acute perpendicular tips. Rectangular blade 50 is a poor choice of precision cutting due to its awkward 90° tips. Further, thin, hard rectangular blade grip 71 is difficult to grab due to its thin, hard surface. The present invention provides significant improvements in precision cutting and grip comfort.

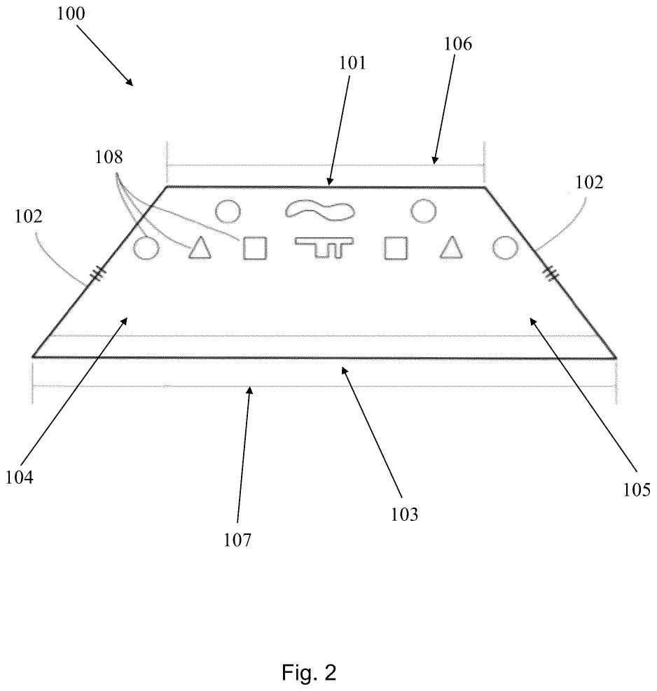

FIG. 2 shows isosceles trapezoid shaped utility blade 100 utilized with the present invention. Blade 100 includes an upper edge 101 with an upper edge length 106. Blade 100 further comprises a cutting edge 103 with a cutting edge length 107 and two vertical sides 102. Blade 100 also includes front side 105 and back side 104, which are essentially identical. Lastly, blade 100 includes holes 108, which may be used to couple the low profile grip as described in reference to later figures. Blade 100 may be made of any suitable material including steel, stainless steel, aluminum, plastic, or any other suitable hard material well known in the art. Upper edge length 106 and cutting edge length 107 may be of any suitable dimension well known in the art. This embodiment of blade 100 shows no indentations in this design along its upper edge 101.

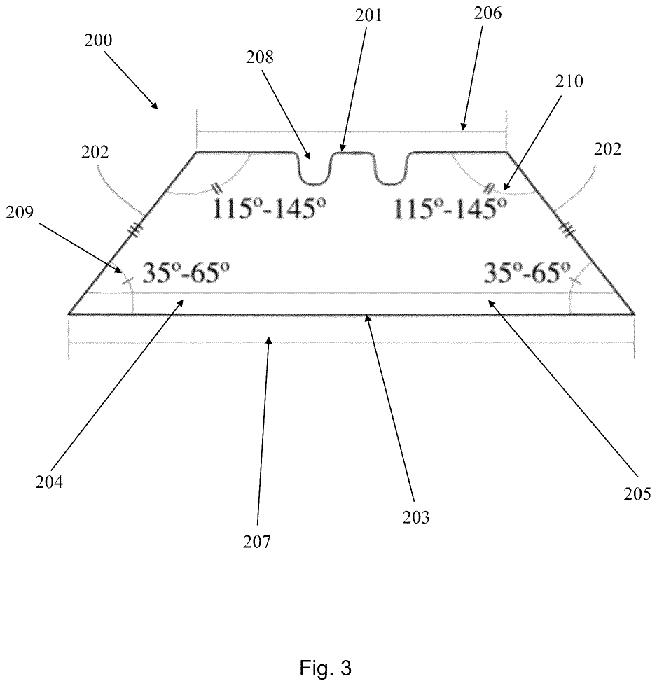

FIG. 3 shows an alternate version of isosceles trapezoid shaped utility blade 200 utilized with the present invention. Blade 200 includes an upper edge 201 with an upper edge length 206. Blade 200 further comprises a cutting edge 203 with a cutting edge length 207 and two vertical sides 202. Blade 200 also includes front side 205 and back side 204, which are essentially identical. Lastly, blade 200 includes indentions 208, formed along upper edge 201, which may be used to couple the low profile grip as described in reference to later figures.

Blade 200 shows an cutting edge angle 209 between vertical edge 202 and cutting edge 203. This cutting edge angle 209 is the angle measured from cutting edge 203 to vertical edge 202 and ranges from 35° to 65°. Blade 200 also shows upper edge angle 210, measured as the angle in degrees between upper edge 201 and vertical edge 202. Upper edge angle 210 for this embodiment ranges between 115° to 145°.

Blade 200 may be made of any suitable material including steel, stainless steel, aluminum, plastic, or any other suitable hard material well known in the art. Upper edge length 206 and cutting edge length 207 may be of any suitable dimension well known in the art.

A first method of fabricating the present low profile grip claimed herein is possible with the following steps: 1) stamping or fine blanking steel blades, 2) removal of any anti-rust agent from the blades, 3) gripping any standard isosceles trapezoid shaped utility blade with the upper edge facing downward, 4) dip the upper edge of the blade to the desired grip height range in vinyl plastisol adhesive or primer (such as those produced under the Avient® brand) for binding a PVC resin to the blade, 5) allow the adhesive or primer to cure, and 6) dip the portion of the blade with the adhesive/prior into a plastisol PVC resin. The adhesive/primer step may be skipped, but that will result in a weaker bond between the resin and blade surface. The longer the blade remains within the dip, the thicker the grip will become.

This method may be duplicated with PVC resin products readily available to consumers such as those sold under the PLASTI DIP® brand. Using this method, each dip of the blade in the material will increase the grip thickness of the grip. For larger grip thicknesses, this method may prove time consuming due to the multiple times the grip must be dipped. This method may also include other materials that may improve the grip such as primer, adhesive, powder coat and other well known in the art. These materials may be applied by spraying, dipping, molding and other methods well known in the art.

An alternate method for manufacturing the present device includes the steps of 1) stamping or fine blanking steel blades into the required shape and sharpness, 2) coating any exposed metal with an anti-rust agent such as oil (as needed) for the type of metal used, 3) allocating and utilizing a selection of blades as template blades for dipping into an industrial plastisol tank in order to make grips, 4) the grips are then removed from the template dipping blades, 5) alternate blades are then coated with primer and/or coated with an adhesive, 6) the grips are then applied to the adhesive coated blades thus completing the product/invention embodiment.

An alternate method for manufacturing the present device includes the steps of 1) stamping or fine blanking steel blades into their shape and sharpness 2) coating any exposed metal with an anti-rust agent such as oil if needed for the type of metal used, 3) inserting the steel blades into an injection mold, 4) injecting the mold with a polymer such as a PVC. This embodiment may be achieved with multiple materials and methods well known in the art.

An alternate method for manufacturing the present device includes 1) casting a blade with its grip section as simply a larger part of the same casting, 2) An optional sharpening process for enhancing the sharpness of the sharp end of the blade, 3) coating any exposed metal with an anti-rust agent such as oil if needed for the type of metal used.

An alternate method for manufacturing the present device includes 1) casting, stamping, or fine blanking a steel blade, 2) coating any exposed metal with an anti-rust agent such as oil (as needed) for the type of metal used, 3) extruding, casting, or injection molding a grip as a separate step, 4) coating any exposed metal with an anti-rust agent such as oil if needed for the type of metal used, 5) coupling the grip to the blade or offering the grip as a separate item for end users to removably-couple to said blades as desired.

In any of the disclosed manufacturing processes it is possible to replace steel as the chosen metal with a different type of metal, alloy or composite. In some cases for certain applications a PVC or plastic substance/material may be used as the blade instead of a metal or steel where a softer sharp edge is needed by the end user, for example, scraping specific type of glass that may be scratchable by a metal or steel blade. In the event a plastic material is used as the blade, the anti-rust steps in any manufacturing process would then be void. In an event where a plastic is used as the blade the entire product may be injection molded in 1 step.

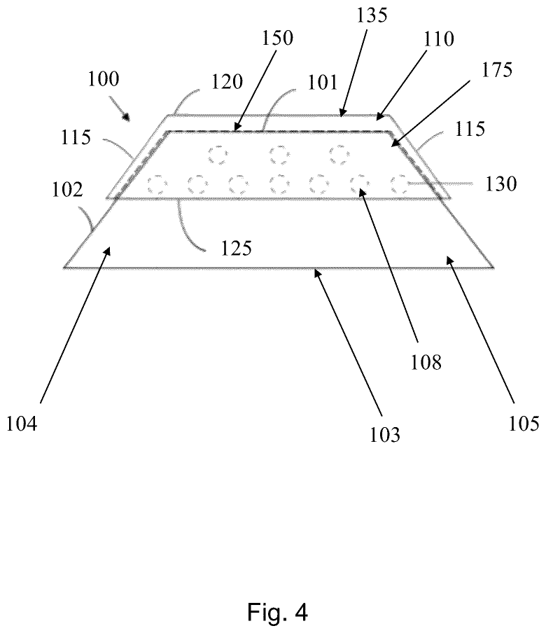

FIG. 4 shows blade 100 with grip 110 fixed in place. In this embodiment, grip 110 is installed covering upper edge 101, the upper portion front side 105, an identical upper portion of back side 104, and the upper portion of both vertical edges 102. Grip 110 comprises a cushioning material 175 covering blade 100 with two vertical edges 115, an upper edge 120, a lower edge 125 and thickness 135. The dimensions of vertical edges 115, upper edge 120 and lower edge 125 are variable with the dimensions of blade 100 and are generally similar or greater than the blade 100 dimensions. The dimensions of vertical edge 115 of grip 110 should not be greater than vertical edge 102 dimension of blade 100, so that grip 110 does not cover cutting edge 103. Thickness 130 for the present embodiment ranges from 0.020″ to 0.525″. Grip holes 130 couple with blade holes 108 to secure grip 110 to blade 100.

Grip 110 may be formed of many materials including PVC/plastisols, plastic polymers, rubbers, metals, alloys, woods, resins, coatings such as a powder coat, or composites and may be manufactured utilizing methods well known in the art such as casting, molding, injection molding, extruding, fine blanking, stamping, machining, dipping, PVC dipping, coating, powder coating, wood working. The blade may be formed of the following materials: steel, stainless steel, alloys, titanium, cobalt, silver, plastics, and composites. Methods of grip attachment to the blade include: friction-fit fastener, screw, bolt, crimping force, welding, laser welding, plastic welding, a blade-thruhole-pattern, casting through a blade-thruhole-pattern, injection molding through a blade-thruhole-pattern, casting over a textured surface, injection molding over a textured surface, casting over surface depressions, injection molding over surface depressions, casting over surface extrusions, and injection molding over a surface extrusions.

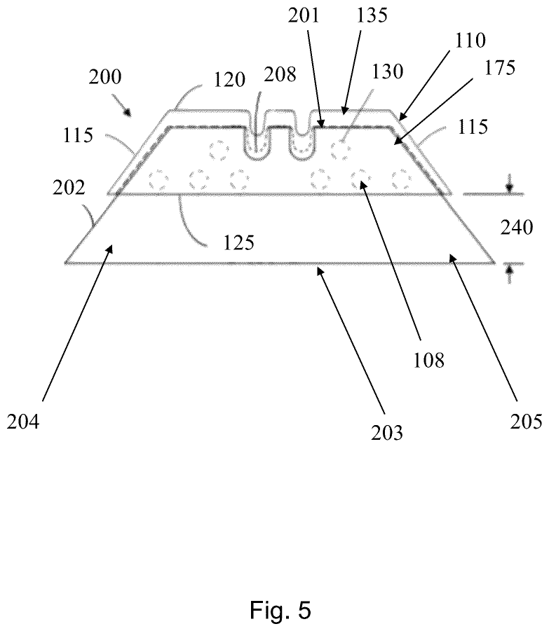

FIG. 5 shows alternative blade 200 with grip 110 fixed in place. In this embodiment, grip 110 is installed covering upper edge 201, the upper portion front side 205, an identical upper portion of back side 204, and the upper portion of both vertical edges 202. Grip 110 comprises a material covering blade 200 with two vertical edges 115, an upper edge 120, a lower edge 125 and thickness 135. The dimensions of vertical edges 115, upper edge 120 and lower edge 125 are variable with the dimensions of blade 200 and are generally similar or greater than the blade 200 dimensions. The dimensions of vertical edge 115 of grip 110 should not be greater than vertical edge 202 dimension of blade 200, so that grip 110 does not cover cutting edge 103. The distance between grip 110 lower edge 125 and cutting edge 203 is visible blade distance 240. Visible blade distance 240 must be greater than zero so that the grip 110 does not cover blade edge 203. Thickness 130 for the present embodiment ranges from 0.005″ to 0.250″. Grip holes 130 couple with blade holes 108 to secure grip 110 to blade 100. Further, in this embodiment, indentions 208 are shown in this embodiment of blade 200. Material of grip 110 may couple with indentions 208 to further secure grip 110 to blade 200.

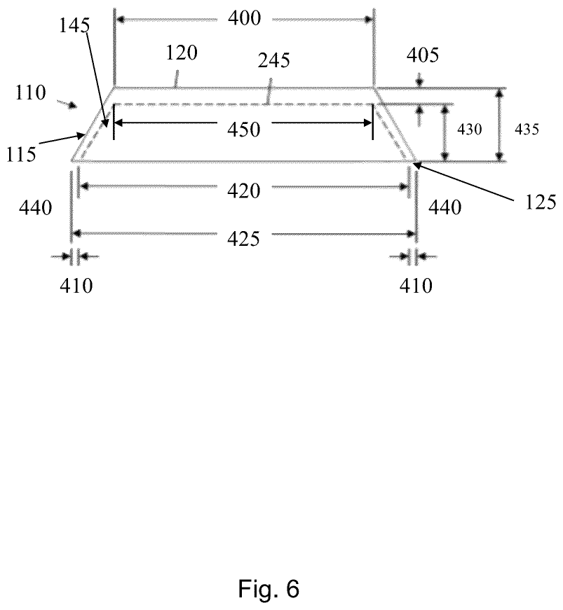

FIG. 6 shows grip 110 without a blade 100 or 200 installed in the grip. Grip 110 comprises a material covering blade 100 with two vertical edges 115, an upper edge 120, a lower edge 125, thickness 135 and inner pocket 145. The dimensions of upper edge 120 are comprised of upper edge max distance 400 and upper edge min distance 450. Upper edge max distance 400 is the measurement of upper edge 120 from the outer edge of the top of grip 110 to the opposite outer edge of the top of grip 110. Upper edge min distance 450 is the measurement of the top edge of pocket 145 of grip 110 from the inner edge of pocket 145 to the opposite inner top edge of pocket 145. The measurement of lower edge 125 is comprised of lower edge max distance 425 and lower edge min distance 420. Lower edge max distance 425 is the measurement of lower edge 125 from the outer edge of the bottom of grip 110 to the opposite edge of the bottom of grip 110. Lower edge min distance 420 is the measurement of the bottom edge of pocket 145 of grip 110 from the inner edge of pocket 145 to the opposite inner bottom edge of pocket 145. The vertical edge thickness 410 measures the thickness between the vertical edge 115 of the grip 110 and the vertical edge 102 or vertical edge 202 of blades 100 and 200. The grip upper edge thickness 405 is the measurement of vertical edge max distance 435 minus vertical edge min distance 430. Vertical edge max distance 435 is measured from the grip lower edge 125 and grip upper edge 120. Vertical edge min distance 430 is measured from the upper edge of the inner pocket 145 to the grip lower edge 125.

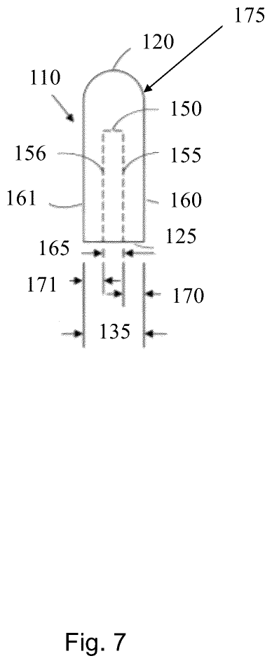

FIG. 7 shows a cross section of grip 110 without a blade installed showing the relative thickness dimensions. This view shows an upper edge 120, a lower edge 125, a front face 160, a rear face 161, a pocket upper edge 150, an interior front face 155, and an interior rear face 166. Furthermore, this side view depicts a front face grip thickness 170, a rear face grip thickness 171, an interior thickness 165 for fitting an isosceles trapezoid shaped utility blade, and a total thickness 135 representing the cumulative thicknesses a front face grip thickness 170, a rear face grip thickness 171, and interior thickness 165. The thickness 170 of the front face 160 shall have a thickness of at least 0.005″ and not more than 0.250″. The thickness 171 of the rear face 161 shall have a thickness of at least 0.005″ and not more than 0.250″. The thickness between the top surface 120 of the grip 110 and its pocket upper edge 150 shall also be at least 0.005″ and not more than 0.250 ″ thick. The total thickness 135 of the interior thickness 165 of the grip 110 and its front face 160 and rear face 161 shall be no less than 0.050″ and no more than 0.525″ thick. These specifications disclose the optimum low profile grip embodiment of the particular isosceles trapezoid shaped utility blade described herein, thus maximizing its uses and applications. These specifications insure precision, maneuverability, and comfort to the user.

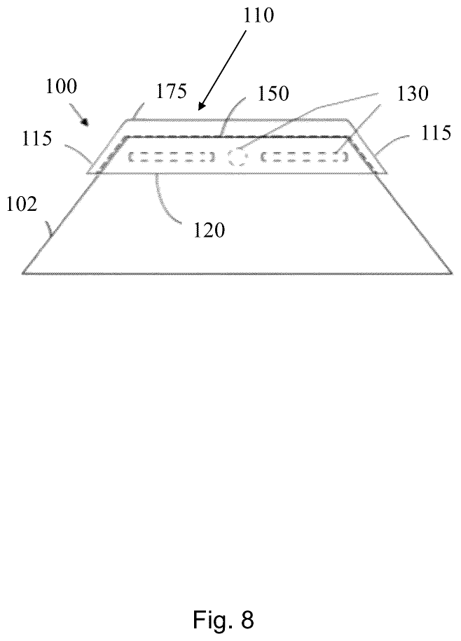

FIG. 8 shows a short low profile cushioning substance 175 coupled to first configuration of holes 130 in the blade 100 being utilized as grip 110. Grip is coupled to blade 100, front face 105, rear face 104 and covering and upper edge 101. The radius of the obtuse corners of cushioning substance 175 is measured between is between its sides 115 and 175. This angle may be any obtuse angle as long as the sides of blade 100 are covered with an appropriate low profile grip thickness of at least 0.005″ and not more than 0.250″.

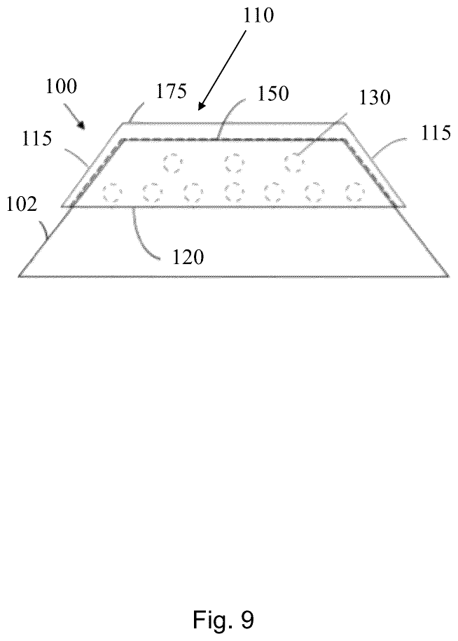

FIG. 9 shows a short low profile cushioning substance 175 coupled to an second configuration of holes 130 in the blade 100 being utilized as grip 110. Grip is coupled to blade 100, front face 105, rear face 104 and covering and upper edge 101. The radius of the obtuse corners of cushioning substance 175 is measured between is between its sides 115 and 175. This angle may be any obtuse angle as long as the sides of blade 100 are covered with an appropriate low profile grip thickness of at least 0.005″ and not more than 0.250″.

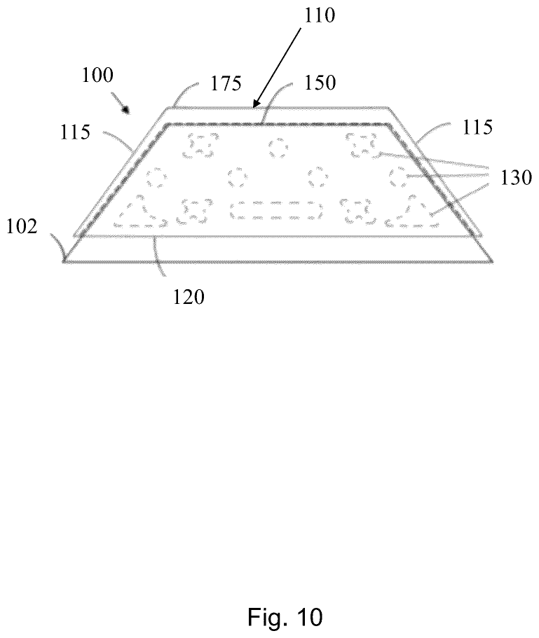

FIG. 10 shows a short low profile cushioning substance 175 coupled to an third configuration of holes 130 in the blade 100 being utilized as grip 110. Grip is coupled to blade 100, front face 105, rear face 104 and covering and upper edge 101. The radius of the obtuse corners of cushioning substance 175 is measured between is between its sides 115 and 175. This angle may be any obtuse angle as long as the sides of blade 100 are covered with an appropriate low profile grip thickness of at least 0.005″ and not more than 0.250″.

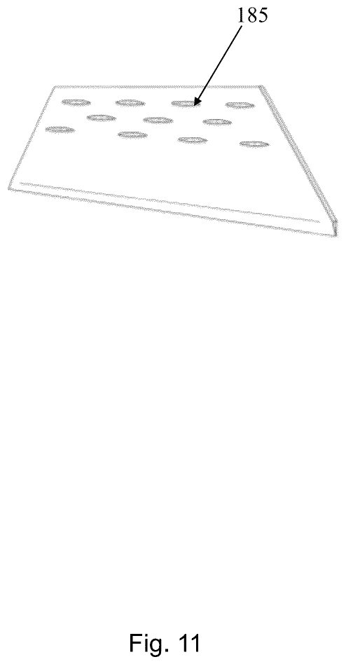

FIG. 11 shows a perspective of an alternative utility blade design including depressions 185 formed in the flat surface of a blade. A short low profile cushioning substance 175 could be coupled to depressions 185 which could also be referred to as knurls.

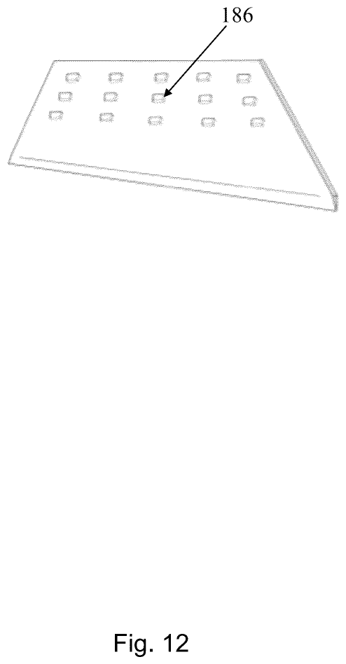

FIG. 12 shows a perspective of an alternative utility blade design including extrusions 186 formed in the flat surface of a blade. A short low profile cushioning substance 175 could be coupled to extrusions 186.

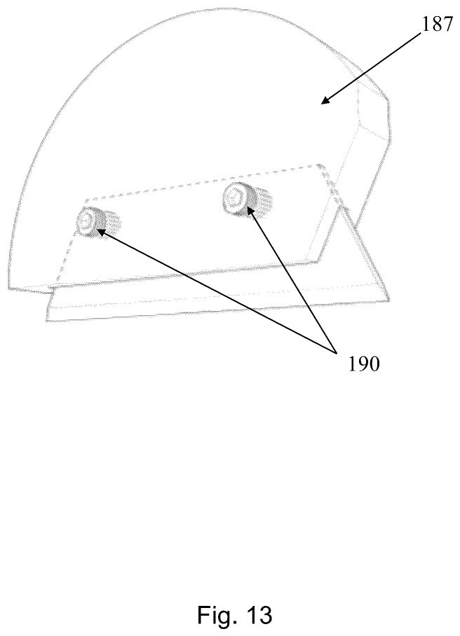

FIG. 13 shows an alternative utility blade design for coupling with a short low profile cushioning substance 175. The alternative utility blade design comprising a larger low profile cushioning substance 187 coupled to the blade via one or more set screws 190 that protrude through the cushioning substance and press against the front or back-face of the blade, further pressing the opposing side of the blade against the opposing interior wall of the cushioning substance yielding a friction fit by screw pressure.

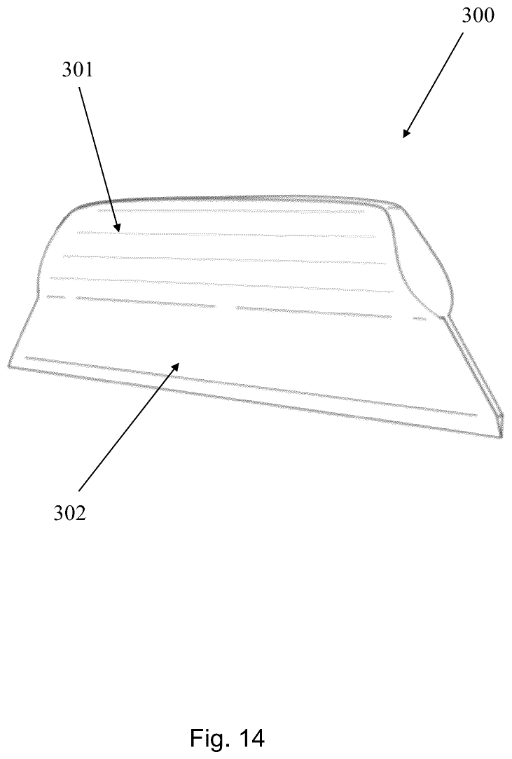

FIG. 14 shows an alternate embodiment integrated grip 300 of the present invention. This integrated grip 300 embodiment includes grip 301 and blade 302. Grip 301 is integrated with blade 302 in this configuration and does not require a 3rd party cushioning substance 175. In this embodiment of the invention herein, the top non-sharp edge of the blade and its obtuse angled sides may take on a more ergonomic form similar to the embodiments utilizing a 3rd party cushioning substance.

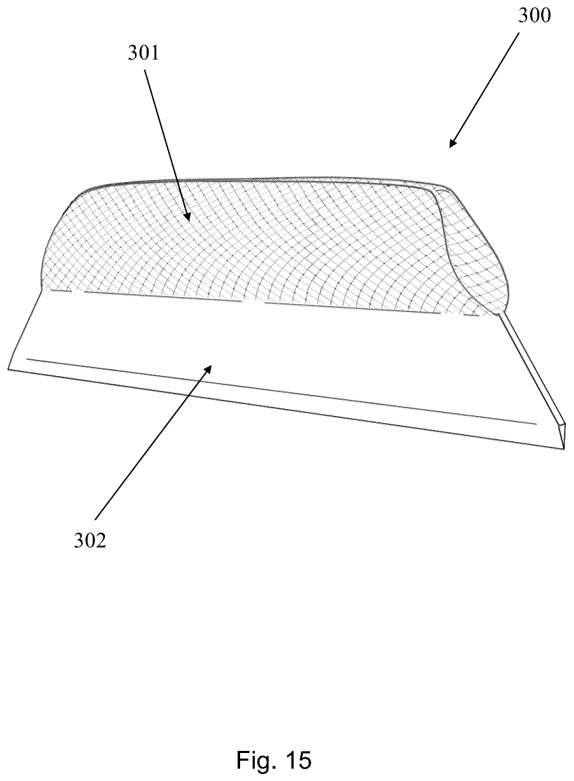

FIG. 15 shows the integrated grip 300 embodiment of FIG. 14 with grip 301 including a texture of etched marks across its surface area such as knurls.

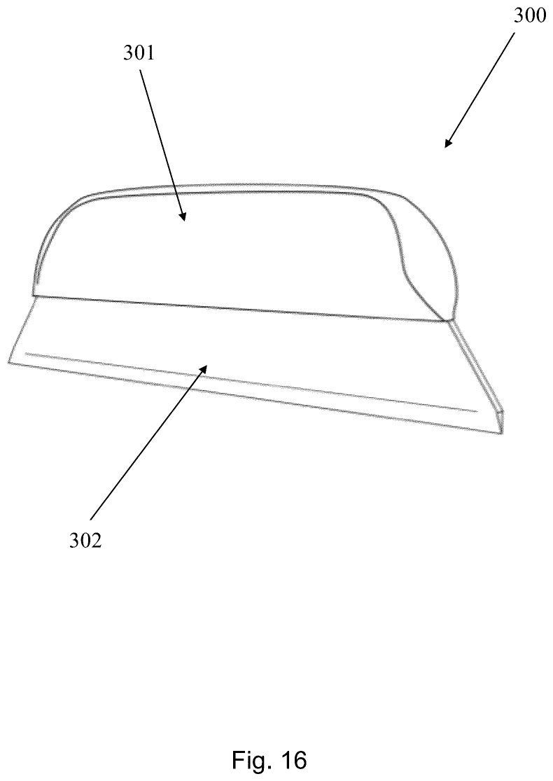

FIG. 16 shows the integrated grip 300 embodiment of FIG. 15 with a coating over grip 301 and embedded into the etched marks for coupling, such as a PVC or plastic injection molding. The coating is installed/formed/placed over the grip 301 or etch marks.

Although the present invention has been described in relation to the above disclosed preferred embodiment, many modifications in design, implementation, systems and execution are possible while still maintaining the novel features and advantages of the invention. The preferred embodiment is not meant to limit the scope of the patent in any way, and it should be given the broadest possible interpretation consistent with the language of the disclosure on the whole.

1. A grip for a cutting blade comprising:
a blade comprising an upper blade edge, a cutting edge and two vertical edges,
a cutting blade angle measured between each vertical edge and the cutting edge, an upper blade angle measured between the upper blade edge and each vertical edge, a blade height, a blade length, and a blade thickness; and
the grip being coupled to the blade wherein the grip has a front face with a front face thickness, a rear face with a rear face thickness, an upper edge thickness, a vertical edge thickness and a total thickness.

2. The grip of claim 1 where the front face thickness is in the range between 0.005″ and 0.250″, the rear face thickness is in the range between 0.005″ and 0.250″, the upper edge thickness is in the range between 0.005″ and 2.0″, the vertical edge thickness is in the range between 0.005″ and 1.0″, and the total thickness is in the range between 0.020″ and 0.525″.

3. The grip of claim 2 where the cutting blade angle is between 35 degrees and 65 degrees, the upper edge blade angle is between 115° and 145°, the blade thickness is in the range of 0.010″ to 0.525″, the blade height is in the range between 0.4″ to 2.00″, and the blade length is in the range between 0.50″ and 3.00″.

4. The grip of claim 2 where the grip is coupled to the blade through one or more holes.

5. The grip of claim 2 where the grip is coupled to the blade by depressions.

6. The grip of claim 2 where the grip is coupled to the blade by extrusions.

7. The grip of claim 2 where the grip is coupled to the blade by a texture wherein the texture is knurls.

8. The grip of claim 1 where the blade is coated in a primer for increasing the bond to the grip.

9. The grip of claim 1 where the blade is coded in an adhesive for increasing the bond to the grip.

10. The grip of claim 1 where the grip is formed from a material selected from the group comprising plastisol, a plastic polymer, a rubber, a metal, an alloy, a wood, a resin, a powder coat, or a composite substance.

11. The grip of claim 1 where the grip is removably coupled to the blade.

12. The grip of claim 1 where the grip is coupled to the blade with a fastener selected from the group comprising friction-fit fastener, screw, bolt, crimping force, welding, laser welding, plastic welding, a blade-thruhole-pattern, casting through a blade-thruhole-pattern, injection molding through a blade-thruhole-pattern, casting over a textured surface, injection molding over a textured surface, casting over surface depressions, injection molding over surface depressions, casting over surface extrusions, and injection molding over a surface extrusions.

13. The grip of claim 1 where a surface of the grip comprises one or more textured areas.

14. The grip of claim 12 where the textured surface is coated in an additional cushioning substance.

15. A method for forming a grip on a cutting blade comprising the steps of:
forming a blade with a cutting edge and an upper edge by stamping a sheet of metal;
removing any contaminants from the blade;
applying an adhesive or primer material to the upper edge of the blade;
curing the adhesive or primer material; and
dipping the upper edge and a portion of the vertical edges and their connecting faces into a PVC resin to form a grip on the blade.

16. The method of forming a grip on a cutting blade of claim 15 further comprising the steps of:
removing the blade; and
installing the grip on a second blade.

17. A method for permanently forming a grip on a cutting blade comprising the steps of:
forming a blade with a cutting edge and an upper edge by stamping a sheet of metal;
removing any contaminants from the blade; and
inserting the blade into an injection mold and injection molding a polymer form over the blade in the shape of a grip.

18. The method of forming a grip on a cutting blade of claim 17 further comprising removably forming a grip on a cutting blade.

19. The method of forming a grip on a cutting blade of claim 17 further comprising the step of coupling the grip on the blade.

20. The method for forming a grip on a cutting blade of claim 17 where the polymer is a PVC.
